(19) United States
(12) Patent Application Publication
(10) Pub. No.: US 2023/0058051 A1
(43) Pub. Date: Feb. 23, 2023

(54) SYSTEM AND METHOD FOR VOICE ACTIVATED FILE TRANSFER

(71) Applicant: Toshiba TEC Kabushiki Kaisha, Shinagawa-ku (JP)

(72) Inventors: Halley BRADT, Laguna Hills, CA (US); Hung TRAN, Mission Viejo, CA (US)

(21) Appl. No.: 17/404,200

(22) Filed: Aug. 17, 2021

(51) Int. Cl. H04L 29/08; G10L 15/22; G10L 15/30

(52) U.S. Cl. CPC H04L 67/06; H04L 67/1097; G10L 15/22; G10L 15/30; G10L 2015/223

(57) ABSTRACT

A system and method is provided for voice activated or touchless file transfer between connected devices. User input for device transfer setup is received identifying a device of interest for file transfer, along with a friendly device name, along with user credentials for device access. Transfer of electronic documents, including scan files or download files, may be initiated by a device such as a multifunction peripheral by a verbal command by a user corresponding to the setup information.

### TECHNICAL FIELD

This application relates generally to transferring of electronic files. The application relates more particularly to directed movement of electronic documents between devices with verbal commands.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

A typical MFP user interface provides a display and tactile human input. Many MFPs employ a touchscreen where various MFP functions can be displayed for touch selection. As used herein, it is to be understood that a touchscreen may be substituted with any display and tactile entry, such as a keyboard, mouse, switch or the like.

### BRIEF DESCRIPTION OF THE DRAWINGS

Various embodiments will become better understood with regard to the following description, appended claims and accompanying drawings wherein:

FIG. 1 an example embodiment of a system for voice activated file transfer;

FIG. 2 is an example embodiment of a networked digital device, such as multifunction peripheral;

FIG. 3 is an example embodiment of a digital device system, such as a computer or smartphone;

FIG. 4 is an example embodiment of a voice activated file transfer system;

FIG. 5 is an example embodiment of a hardware block diagram for voice activated file transfer;

FIG. 6 is an example embodiment of a software module block diagram 600 of a voice activated transfer system;

FIG. 7 is an example embodiment of a voice activated file transfer system;

FIG. 8 is an example embodiment of a user interface with a voice activated transfer system;

FIG. 9 is an example embodiment of a system to complete a voice activated file transfer for a scan file; and

FIG. 10 is an example embodiment of user interface interactions for devices that have been set up by a user.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

As noted above, MFP functions may be displayed with various screens on a device touchscreen, such as with selectable icons and text input. There are some users that have physical challenges that may prevent or inhibit their use of a touchscreen. Examples may include users with missing appendages or paralysis. In some instances, it may be undesirable for a user to touch a common touchscreen, such as when there is a risk of transmission of germs such as microscopic bacteria, viruses, fungi, or protozoa that can cause disease.

In example embodiments herein, users take advantage of their portable digital devices, such as smartphones or tablet computers, to verbally direct an MFP to send one or more electronic files to a specified location. Transfers can be to any device for which a user has established as a connection having a name supplied by the user. There are several portable device operating systems being used today. The most well-known mobile operating systems include Android, iOS, Windows phone OS, and Symbian. Users of iOS are able to process information and send information to each other using Apple's AirDrop technology. With AirDrop, users having Apple devices running iOS 7, iPadOS 13, OS X 10.10, or later versions, can wirelessly send photos, videos, websites, locations, and more to other nearby devices and Mac computers. AirDrop transfers information using Wi-Fi and Bluetooth. Both must be turned on. To use AirDrop, a user needs to be signed in with their Apple ID. Transfers are encrypted for security. With iOS devices, there is no ability to transfer files to non-Apple devices, such as MFPs, or devices running Android or Windows operating systems.

In example embodiments herein, a voice activated transfer system enables a phone, computer, or MFP to send files to other phones, other computers or other MFPs using voice commands and Airdrop for Apple systems, Bluetooth technology for non-Apple systems or via embedded software applications in connected devices. This enables touchless file transference which can be accomplished in multiple languages.

Example embodiments herein provide a voice activated transfer program that enables users to use vocal commands to send files to networked devices, such as directing an MFP, desktop, or computer to transfer files to one or more desired locations. This is suitably accomplished with applications or apps on or more devices.

In further example embodiments, the voice activated transfer system users can pre-associate names with their devices of interest. Users need only speak a command, such as “scan document” or “transfer to [named] computer.” Users can also speak into any device running the voice activated transfer system such as their phone, computer or MFP. File transfers via vocal commands are made to another paired device of their choosing. Multiple devices are also suitably paired.

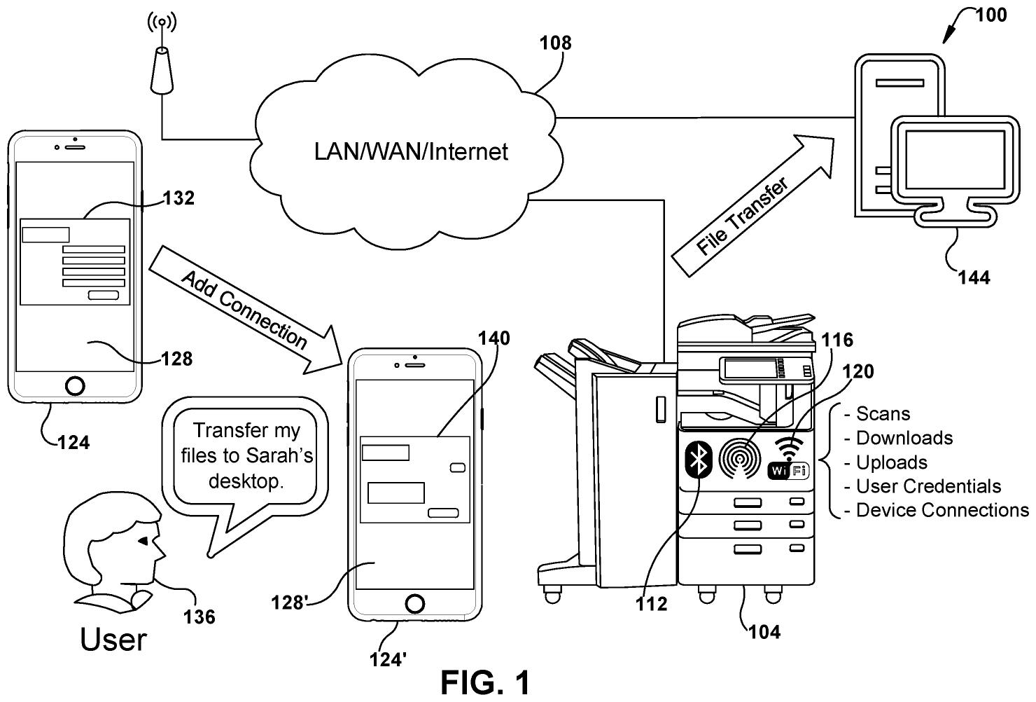

FIG. 1 is an example embodiment of a system 100 for voice activated file transfer. One or more MFPs, such as MFP 104 in is in data communication with one or more devices through a data interface. An MFP data interface includes network cloud 108, suitably comprised of a local area network (LAN), a wide area network (WAN), which may comprise the Internet, or any suitable combination thereof. Network cloud 108 is comprised of any suitable wireless or wired data connection or combination thereof. A data interface of MFP 104 also suitably includes wireless communication protocols, such as Bluetooth 112, Airdrop 116 and Wi-Fi 120. Also in data communication with network cloud 108 and MFP 104 via the data interface is a portable data device, illustrated as smartphone 124. Touchscreen 128 of smartphone 125 displays dialog box 132, detailed below, to allow a user to setup a device connection for use with voice activated file transfers. In the illustrated example, one or more connections has been added for user 136, an example dialog box 140 appears on display 128′ of smartphone 124′. An example connection interface will be detailed further below.

In the system of FIG. 1, user 136 issues a voice command to transfer a file from MFP 104 to workstation 144, or any other device for which a connection has been established. Devices, such as MFP 104, smartphone 124 or workstation 144 are suitably enabled for voice activated file transfers.

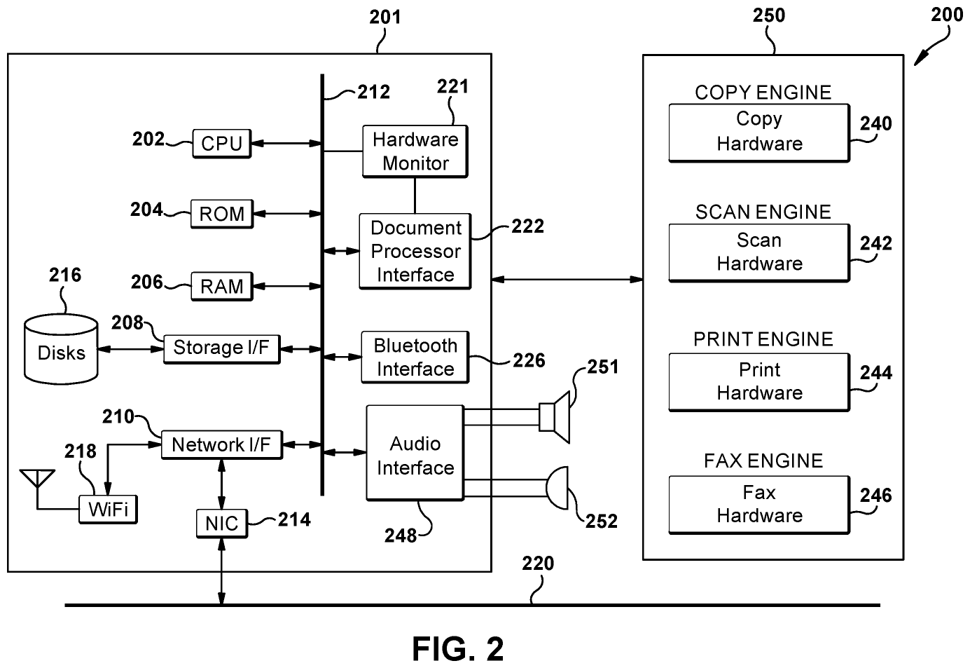

Turning now to FIG. 2, illustrated is an example embodiment of a networked digital device comprised of document rendering system 200 suitably comprised within an MFP, such as with MFP 104 of FIG. 1. It will be appreciated that an MFP includes an intelligent controller 201 which is itself a computer system. Thus, an MFP can itself function as a server with the capabilities described herein. Included in intelligent controller 201 are one or more processors, such as that illustrated by processor (CPU) 202. Each processor is suitably associated with non-volatile memory, such as read-only memory (ROM) 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired interface or physical network connection 220, or to a wireless data connection via wireless network interface 218. Example wireless data connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like.

Processor 202 can also be in data communication with any suitable user input/output (I/O) interface 219 which provides data communication for interfacing with user peripherals, such as displays, keyboards, mice, track balls, touch screens, or the like. Processor 202 can also be in communication with hardware monitor 221, such as a page counter, temperature sensor, toner or ink level sensor, paper level sensor, or the like.

Also in data communication with data bus 212 is a document processor interface 222 suitable for data communication with the document rendering system 200, including MFP functional units. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform. Also in data communication with data bus 212 is Bluetooth interface 226 and audio interface 248. Audio interface 248 provides sound output from speaker 251. Analog data, such as speech, is captured from microphone 252 and converted to digital data via audio interface 248.

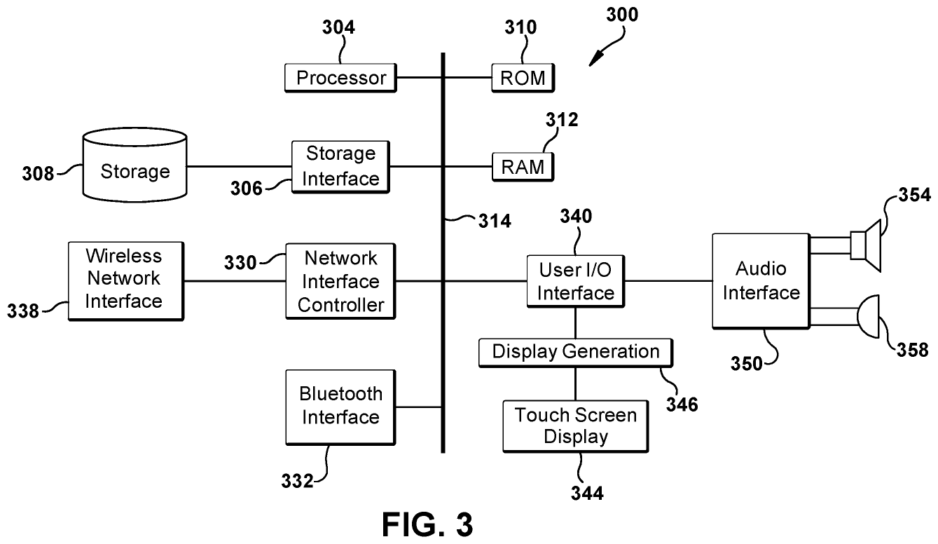

Turning now to FIG. 3, illustrated is an example embodiment of a digital data processing device 300 such as smartphone 124 and workstation 144 of FIG. 1. Components of the digital data processing device 300 suitably include one or more processors, illustrated by processor 304, memory, suitably comprised of read-only memory 310 and random access memory 312, and bulk or other non-volatile storage 308, suitably connected via a storage interface 306. Data communication among and between components is suitably accomplished by data bus 314. A network interface controller 330 suitably provides a gateway for data communication with other devices, such as via wireless network interface 338. Also in data communication with data bus 314 is Bluetooth interface 332. A user input/output interface 340 suitably provides display generation 346 providing a user interface via touchscreen display 344, suitably displaying images from display generator 346. Also in data communication with input/output interface 340 is audio interface 350 which provides sound output from speaker 354. Analog data, such as speech, is captured from microphone 358 and converted to digital data via audio interface 350. It will be understood that the computational platform to realize the system as detailed further below is suitably implemented on any or all of devices as described above.

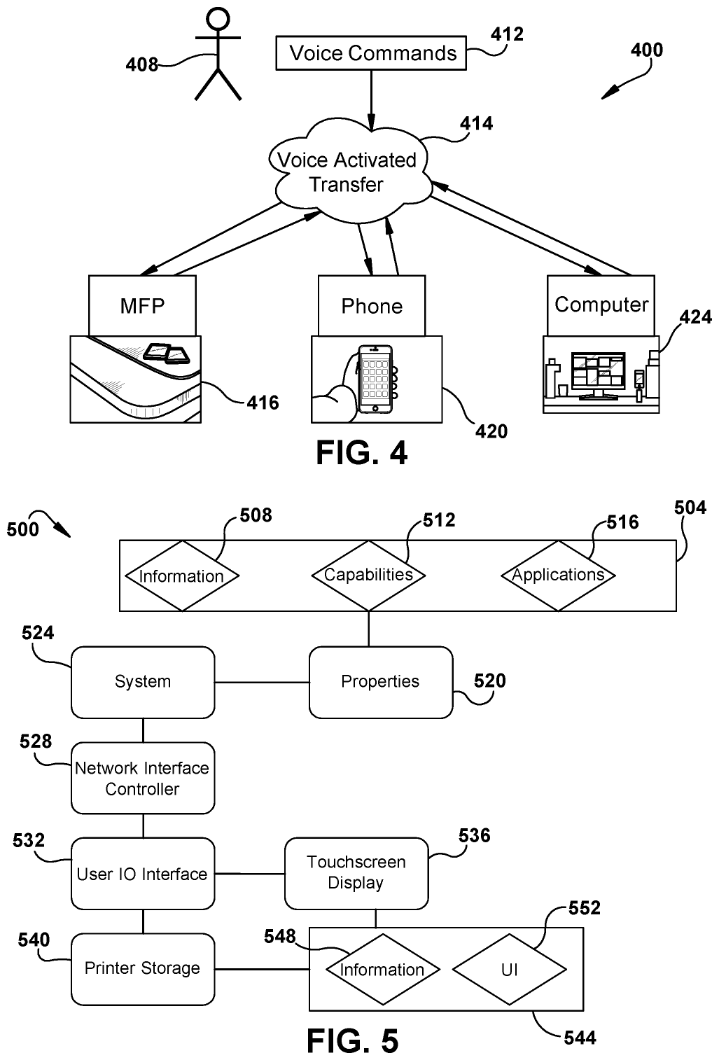

FIG. 4 is an overview if an example embodiment of a voice activated file transfer system 400. In the illustrated example, user 408 supplies voice commands 412 for voice activated file transfer 414. Voice activated file transfer is available for device, such as MFP 416, smartphone 420 and computer 424.

FIG. 5 is an example embodiment of a hardware block diagram 500 for voice activated file transfer. Voice activated transfer setup 504 includes information 508, such as device identification, capabilities 512, such as device capabilities and applications, and applications 516 to realize voice activated transfer. Setup information provides properties 520 which are applied to transfer system 524. File transfers are realized via network interface controller 528. User control is provided via input/output interface 532 working in conjunction with touchscreen display 536 and printer storage 540. Touchscreen display 536 and printer storage 540 provide user output 544 comprising activity information 548 and user interface activity 552.

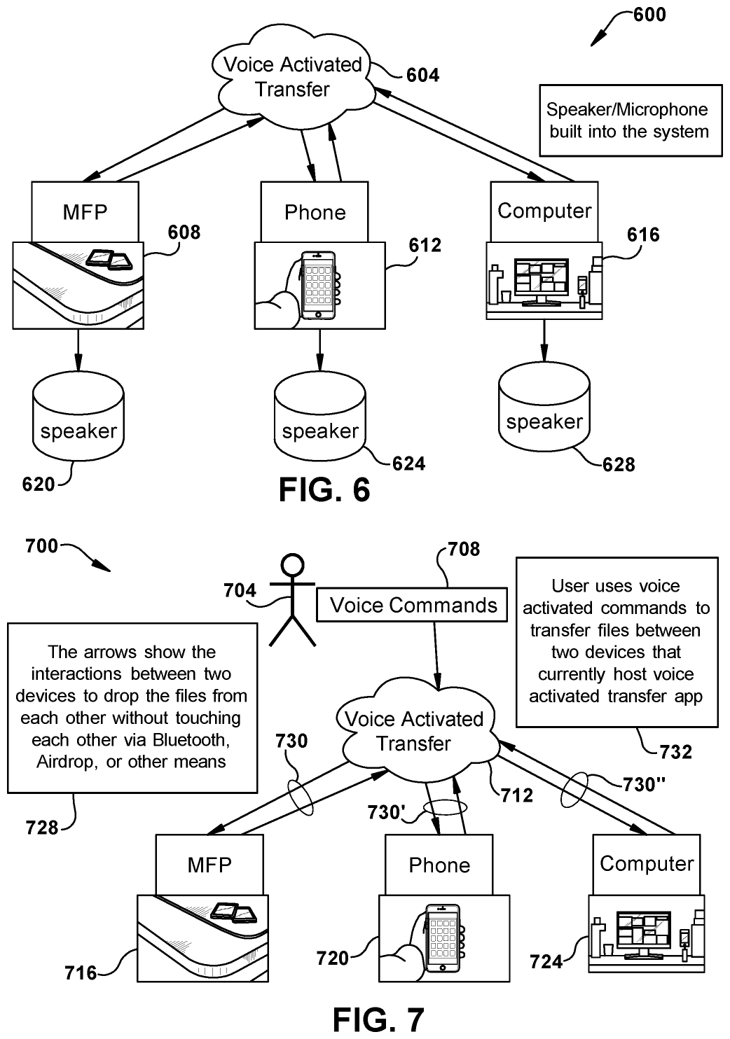

FIG. 6 is an example embodiment of a software module block diagram 600 of a voice activated transfer system. In the illustrated embodiment, voice activated transfer 604 can be accomplished by any or all of MFP 608, smartphone 612 or computer 616. Each device is provided with a digital microphone, as well as with speakers 620, 624 and 628, respectively.

FIG. 7 is an example embodiment of a voice activated file transfer system 700. User 704 supplies voice commands 708 for voice activated transfer 712. File transfer is among or between MFP 716, smartphone 720 or computer 724. As denoted by block 728, arrows 730, 730′ and 730″ illustrate touchless file transfer interactions between two or more devices, using any suitable data transfer system, such as Bluetooth or Airdrop. Block 732 illustrates how voice activated file transfer is accomplished by applications running on devices such as MFP 716, smartphone 720 or computer 724.

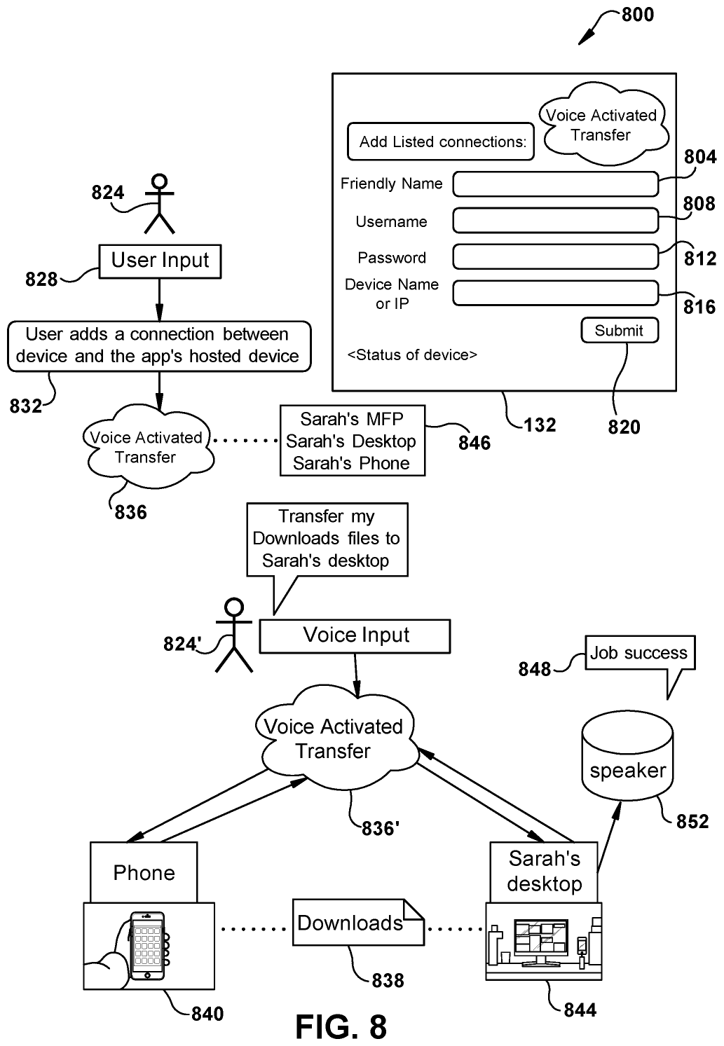

FIG. 8 is a flowchart 800 for an example embodiment of a user interface with a voice activated transfer system to setup and realize a file transfer comprised of a downloaded file. Dialog box 132 is displayed on a user device, such as smartphone 124 (see FIG. 1). Dialog box 132 is displayed for users to setup devices for file transfer. The user supplies a user-friendly name, such as “Sarah's Computer,” in text block 804, their username in text block 808, their device login credentials, such as a password, in text block 812 and a device name at text block 816. When the information fields are complete, the user sets a device by touching submit button 820.

In a setup process, user 824 provides input at block 828 to add a connection between a device and a device hosting an application at block 832. This facilitates voice activated transfer 836 to one or more of devices previously set up 846. Realization of a voice activated transfer 836′ from a user 824′ transfers a download file 838 between smartphone 840 and Sarah's desktop computer 844. An audible indicator 848 of a successful file transfer is generated from speaker 852 which is illustrated as associated with computer 844, but can be generated by any suitable device or multiple devices.

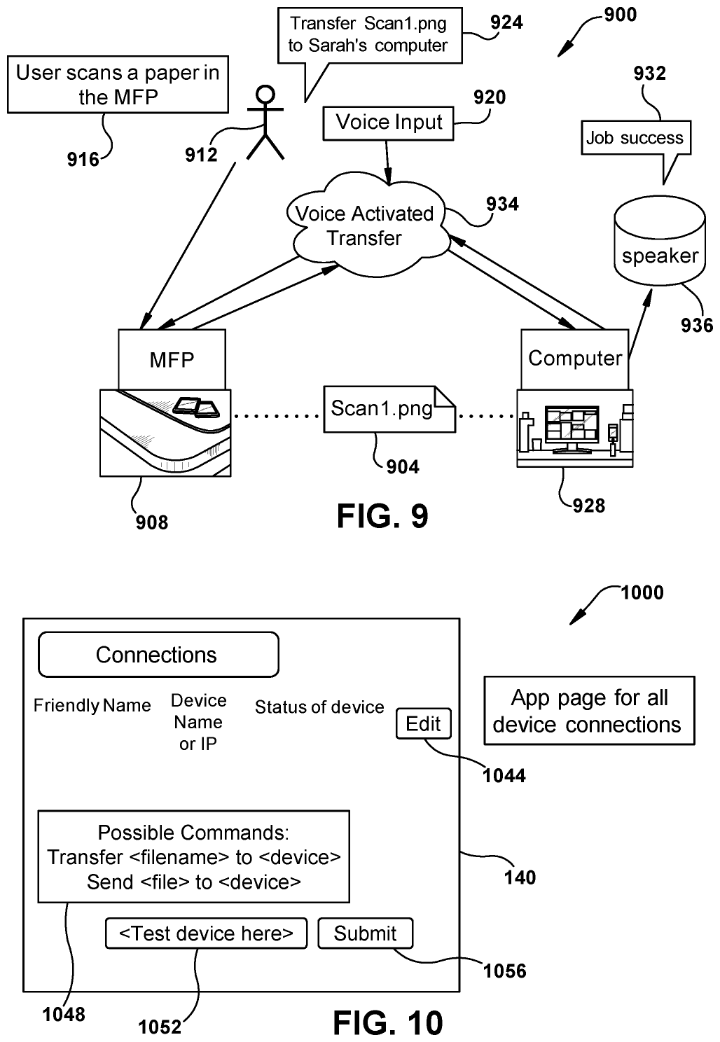

FIG. 9 illustrates example embodiment of a system 900 to complete a voice activated file transfer for a scan file 904 generated by scanning a tangible document on MFP 908 by user 912 at block 916. User 912 supplies voice input 920 with instructions 924 to transfer scan file 904 to computer 928 by voice activated transfer 934. Upon successful transfer, success notification 932 is generated by speaker 936, illustrated as associated with computer 928.

FIG. 10 illustrates an example embodiment of user interface interactions for devices that have been set up by a user, such as example dialog box 140 on smartphone 124 (FIG. 1). Dialog box 140 displays information previously supplied by a user during a device setup, such as that illustrated by FIG. 8. User information including friendly name, device name or IP address previously supplied by the user, along with a current device status, are displayed. Previously supplied information may be modified by selection of edit button 1044. A listing of available verbal commands for the listed device are displayed in block 1048. A device test may be initiated by identifying the device in box 1052 and entering submit button 1056.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions. If a user wishes to test a particular device, they can identify their device of interest in text entry window 152 and hit submit button 156, wherein a test of the device is made and results displayed to the user.

1. A system comprising:
one or more processors;
memory storing one or more electronic documents;
the memory further storing a plurality of device connections for an identified user, wherein each device connection is associated with a data device identified by a user selected device name and a data transfer protocol;
one or more data interfaces;
the one or more processors further configured to receive, via one of the one or more data interfaces, voice command data from the identified user comprising two of the device names;
the one or more processors further configured to determine a data transfer protocol corresponding to a data transfer between devices associated with the two device names;
the one or more processors further configured to select a determined data transfer protocol; and
the one or more processors further configured send the one or more electronic documents to each device associated with the received one or more user selected device names via the one or more data interfaces via selected data transfer protocol.

2. The system of claim 1 further comprising a scanner configured to generate the one or more electronic documents.

3. The system of claim 1 wherein the one or more processors is further configured to download the one or more electronic documents into the memory via the one or more data interfaces.

4. The system of claim 1 wherein one of the one or more data interfaces is comprised of a digital microphone configured to receive a voice command from the identified user to generate the voice command data.

5. The system of claim 4 wherein one of the one or more data interfaces include a Wi-Fi interface and a Bluetooth interface, one of more of which is configured to receive the voice command from a portable data device associated with the identified user and wherein the selected data transfer protocol is comprised of Airdrop using both the Wi-Fi and Bluetooth interfaces when the two devices are iOS devices and wherein the selected data transfer protocol is comprised of Bluetooth when the two devices are not comprised of iOS devices.

6. The system of claim 1 where the one or more processors is further configured to generate a notification to the identified user when the one or more electronic documents have been sent to each of the devices associated with the received one or more user selected device names.

7. The system of claim 6 wherein the one or more processors is further configured to generate the notification as an audible alert from an associated speaker.

8. A method comprising:
storing one or more electronic documents in a memory;
storing, in the memory a plurality of device connections for an identified user, wherein each device connection is associated with a data device identified by a user selected device name and a data transfer protocol;
receiving, one or more data interfaces, voice command data from the identified user comprising one or more of the user selected device names;
determining a data transfer protocol corresponding to a data transfer between devices associated with the two device names;
selecting a determined data transfer protocol; and
sending the one or more electronic documents to each device associated with the received one or more user selected device names via the one or more data interfaces via the selected data transfer protocol.

9. The method of claim 8 further comprising scanning a tangible document to form the one or more electronic documents.

10. The method of claim 8 further comprising downloading the one or more electronic documents into the memory via the one or more data interfaces.

11. The method of claim 8 wherein further comprising receiving a voice command from the identified user to generate the voice command data.

12. The method of claim 11 further comprising:
receiving the voice command via Wi-Fi or Bluetooth from a portable data device associated with the identified user; and wherein
the selected data transfer protocol is comprised of Airdrop via a Wi-Fi interface and a Bluetooth interface when the two devices are comprised of iOS devices, and
the selected data transfer protocol is via the Bluetooth interface when the two devices are not comprised of iOS devices.

13. The method of claim 8 further comprising generating a notification to the identified user when the one or more electronic documents have been sent to each of the devices associated with the received one or more user selected device names.

14. The method of claim 13 further comprising generating the notification as an audible alert from an associated speaker.

15. A system comprising:
a multifunction peripheral (MFP) including,
an MFP processor,
a data interface including an MFP wireless data interface and a network interface,
MFP memory storing one or more electronic documents,
the MFP memory further storing one or more device connections for an identified user, wherein each device connection is associated with a device having a user selected device name, wherein each device having an iOS operating system is associated with an Airdrop transfer protocol using Wi-Fi and Bluetooth, and each device without an iOS operating system is associated with a Bluetooth transfer protocol,
the MFP processor configured to receive voice command data comprising one or more device names from the identified user via the MFP wireless data interface,
the MFP processor further configured to determine one or more data transfer protocol corresponding to a data transfers between devices associated with the two or more device names;
the MFP processor further configured to select one or more determined data transfer protocol; and
the MFP processor further configured to send the one or more electronic documents to each device associated with the each device name in the voice command data via the one or more selected data transfer protocol; and
a portable data device (PDD) including,
a PDD processor,
PDD memory,
a microphone configured to generate the voice command data in accordance with speech input from the identified user, and
the PDD processor configured to send the voice command data to the MFP wireless data interface via a PDD wireless data interface.

16. The system of claim 15 wherein the PDD wireless data interface is configured for data communication via Wi-Fi or Bluetooth.

17. The system of claim 16 wherein the PDD processor is further configured to send a voice command to the MFP wireless data interface via Apple Airdrop.

18. The system of claim 16 wherein the one or more electronic documents are comprised of a scan or a downloaded file.

19. The system of claim 18 wherein one or both of the MFP processor and the PDD processor are configured to generate a notification to the identified user when the one or more electronic documents are sent to each device.

20. The system of claim 19 wherein the notification is an audible notification generated from one or more speakers associated with the MFP or the PDD.
